(19) United States
(12) Patent Application Publication
(10) Pub. No.: US 2009/0139162 A1
(43) Pub. Date: Jun. 4, 2009

(54) Bedroom windows that opens itself to prevent carbon monoxide poisoning without external electrical supply

(76) Inventor: Alfredo Mancini, Manhasset, NY (US)

Correspondence Address: Alfredo Mancini, 210 Chestnut Rd., Manhasset, NY, 11030, US

(21) Appl. No.: 11/998,681

(22) Filed: Nov. 30, 2007

(51) Int. Cl. E06B 7/02; G08B 17/10

(52) U.S. Cl. 52/204.5; 454/225; 340/632; 340/693.11; 49/13; 49/31

(57) ABSTRACT

A bedroom window that detects predetermined levels of carbon monoxide and automatically open by itself to save the occupants lives without any external electrical supply, replaceable alkaline batteries or any human action; this lifesaver window is self-contained, pre-assembled, solar-powered, environmentally friendly and able to open the window sash by itself to allow the CO to escape, to reduce CO concentration, to let the outside clean air to enter the room, to sound it's alarm, and to trigger the Fire & Police Private Central Station Alarm; it can be installed as new or as a replacement window in homes, hotels, hospitals, dormers or wherever humans or animals live; can be manufactured in different sizes and styles to accommodate any architectural design and furthermore it installation requires the same skills & tools needed to install a regular window without the need of other trades.

### BACKGROUND OF THE INVENTION

1. Field of Invention

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

This invention relates to a new window with built-in devices that can monitor the inside environment in a room where humans or animals live, specially in bedrooms where humans sleep and more particular to this new window is that when it senses dangerous levels of carbon monoxide it automatically opens by itself to reduce the concentration of this deadly gas allowing a flow of outside air to enter the room and ventilate and mix new oxygen inside the room to save the occupants' lives without depending on any external power supply, a short term life replaceable alkaline batteries or any human physical action.

To be more specific, the real purpose of this new invention is to help minimize and or avoid the death from carbon monoxide poisoning of human beings including animals, that according to a repot from Judith Katz, Director Air Protection Division U.S. EPA Region III (Release date: Feb. 9, 1999): “Every year, poisonous gas backup from clogged chimney or defective furnace as well kerosene heaters, propane heaters, electrical generators or domestic gas cooking burners and ovens, kill 700 Americans.”

The existing carbon monoxide detectors that comply with UL standard 2034 (1998 revision) and the IAS 6-96 new standard, are doing a great job protecting and preventing the loss of life, but some subjects still need improvement and effectiveness in saving lives and those are the dependency in domestic electrical supply and replaceable short term life alkaline batteries as well the inconsistency of humans in replacing dead batteries, and more in particular is that the current carbon monoxide detectors do not take any action to resolve the problem when an emergency takes place; it only gives a warning sound alert.

When the above emergency takes place and people start getting poisoned by carbon monoxide disregarding the source; there is a need for an immediate action: provide a proper ventilation and supply dean air with oxygen or the occupant will die, poisoned by the accumulated carbon monoxide. This is a confirmed fact, (Contact Information: Carol Febbo (215) 814-2076 Air Protection Division U.S. EPA Region III).

The invention that I claim, will take the physical action to resolve the problem immediately when the emergency takes place: giving an automatic “first aid of fresh air” to the unaware occupants, without depending on any external power supply or a short term life replaceable alkaline batteries or human help, while at the same time triggering the private central station alarm company, which would alert the Fire & Police Department to provide immediate assistance to humans and/or animals and to protect the opened affected structure of the residence if at the time of the occurrence the residence is unoccupied.

The Ni—Cd rechargeable batteries that supply the electrical power to the built-in carbon monoxide detector will be fully charged by the solar cell built-in the exterior seal of the window, exposed to the daylight an average of 10 hours a day, 365 day a year (including cloudy days), and its operation will not depend on unreliable source of domestic electrical supply or replaceable short term life batteries or the inconsistency of humans to replace the discharged dead batteries.

The built-in carbon monoxide detector of this novel invention, complying with the latest UL standards, will detect the predetermined dangerous level of carbon monoxide and within seconds, this device will trigger the electric “un-latch device” that will pop open the window sash, pushed by the built-in springs.

This “un-latch device” is powered by a separate set of Ni—Cd rechargeable batteries independent of the Ni—Cd rechargeable batteries that supply the electrical power to the built-in carbon monoxide detector, this second set of Ni—Cd rechargeable batteries is charged by the solar cells built-in in the exterior seal of the window, exposed to daylight an average of 10 hours a day, 365 day a year (including cloudy days), the same way as the first set of Ni—Cd rechargeable batteries previously described.

When this new window detects a dangerous level of carbon monoxide, this new built-in carbon monoxide detector will sound an alarm and trigger the alarm relay of the accessible contacts connecting to a private central station alarm company, which in turn would alert the Fire & Police Department to provide immediate assistance to the humans and/or animals.

The opened window will accomplish: the ventilation of the enclosed room by immediately allowing a substantial percentage of the concentrated carbon monoxide to escape through the window and at the same time allowing the outside air to enter the room carrying the much needed oxygen necessary to help, prevent and/or avoid death and the loss of humans beings without any other human assistance; in addition, the private central station alarm company connected to the accessible contacts, provided in this novel invention, would alert the Fire & Police Department for them to assist the occupants as well.

Through the above described, I claim from the present invention: that it can make a difference in the life of many people including animals, and the use of this invention can change future EPA reports of the humans that die poisoned by carbon monoxide in the USA.

2. Description of Related Art

Currently used carbon monoxide detectors only protect the occupants with an alarm sound which alerts the occupants that the levels of carbon monoxide reached a dangerous level of carbon monoxide.

These present day carbon monoxide detectors that alert the occupants only with an alarm sound are not efficient enough, especially when in the majority of the carbon monoxide detectors are located only in the hallways of every level of the residential homes, making this factor an issue in how well the persons can hear the sound alarm from the bedrooms, even if carbon monoxide detectors are located in the bedrooms, we have to have the following in considerations.

Most of the elderly people normally have a percentage of hearing loss as well as a very slow reaction to emergencies in addition, confusion due to the age.

This also apply for young children's; even that they can hear the alarm, they don't know what it is for, or what to do, this two age categories are the most sensitive and most likely to be affected, and be poisoned by carbon monoxide in a short amount of time even with lower PPS (Particles per second), of carbon monoxide.

The remaining age group people, can also have problems hearing the warning alarm of the present day carbon monoxide detectors, if they are sleeping, overtired, stressed from daily activities or under the influence of medication or alcohol in the blood.

Present day line voltage carbon monoxide detectors and alarms can lose their warning capabilities and become an ineffective protection as a result of faults in the electrical power supply, which is especially vulnerable in windy or rainy days as well in snowstorms.

The other present day carbon monoxide detectors and alarms, powered by batteries are also affected and can lose their warning capabilities by the inconsistency of the occupants (human error) in replacing old/discharged batteries, thus, inactivating the system.

Other present carbon monoxide protection for human beings as: U.S. Pat. No. 7,183,933 “Garage carbon monoxide detector with automatic garage door opening command”, only protect human beings and animals, when the source of the carbon monoxide come from the internal combustion of automobiles running inside the garage.

The above invention will not protect human beings and animals, when the source of the carbon monoxide come from other sources as gas backup from clogged chimney, defective furnace, kerosene heaters, propane heaters, or domestic gas cooking burners and ovens, used as a emergency source of heat when power failures shut down the heating furnace. Furthermore, this described garage door will not function and will not protect human beings and animals, when a power failure occurs.

The new “Live saver bedroom window that automatically opens by it self to prevent death from carbon monoxide poisoning without the need of any external electrical supply” that I claim, will protect the human beings and animals disregarding the source of the carbon monoxide and any power failures.

Other present carbon monoxide protection for human beings as: “Window convenience and security system”, United States patent (Application 20070210737), also will not function and will not protect human beings and animals, when a power failure occurs.

The new “Live saver bedroom window that automatically opens by it self to prevent death from carbon monoxide poisoning without the need of any external electrical supply” that I claim, will protect the human beings and animals in any power failure, not depending on too many sensors, wireless devices, main control panels, motor drives, microchips, etc. and the supply of electrical power as the “Window convenience and security system”, United States patent (Application 20070210737).

Furthermore, the advantages of this new window that I claim: “Lifesaver bedroom window that automatically opens by it self to prevent death from carbon monoxide poisoning without the need of any external electrical supply”, is a self contained window that can be installed by a mechanic carpenter without the needs of other trade mechanics, does not need any electrical or mechanical assemble or installation.

Another existing related carbon monoxide protection as: “Method and devices for improving indoor air quality using window” United States patent (Application 20060002836), relates to a system to monitor the indoor air quality that when detect abnormal air conditions (as accumulation of carbon monoxide), this invention solves the problem “forcibly exhausting the contaminated indoor air through an exhaust path provided at the window frame by an exhaust fan provided by a motor”.

This described existing patent “method and devices for improving indoor air quality using window” (Application 20060002836), will not function efficiently and will not protect human beings and animals, because the exhaust fan provided by a motor will be inoperable in the presence of a power failure.

The new “Lifesaver bedroom window that automatically opens by itself to prevent death from carbon monoxide poisoning without the need of any external electrical supply” that I claim, will protect the human beings and animals disregarding any power failures via my innovated method of operation.

While this invention has been described in conjunction with the specific embodiments of a hoper window, described above in claim 1, it is evident that many alternatives, combinations, modifications and variations are apparent to those skilled in the art. Accordingly, the preferred embodiments of this invention, as set forth above are intended to be illustrative only, and can be used in different models and styles of windows and not in a limited sense. Various changes can be made without departing from the spirit and scope of this invention.

### BRIEF DESCRIPTION OF THE DRAWINGS

The related features of this invention will become more apparent and the invention itself will be better understood by referencing the following description of the invention in conjunction with the accompanying drawings, wherein:

FIG. 1 Illustrative diagram of the electrical devices. (Drawing Page 1 of 4)

FIG. 2 Interior Front View of the window. (Drawing Page 2 of 4)

FIG. 3 Side view of the window. (Drawing Page 3 of 4)

FIG. 4 Exterior Front View of the window. (Drawing Page 4 of 4)

### DETAILED DESCRIPTION OF THE DRAWINGS

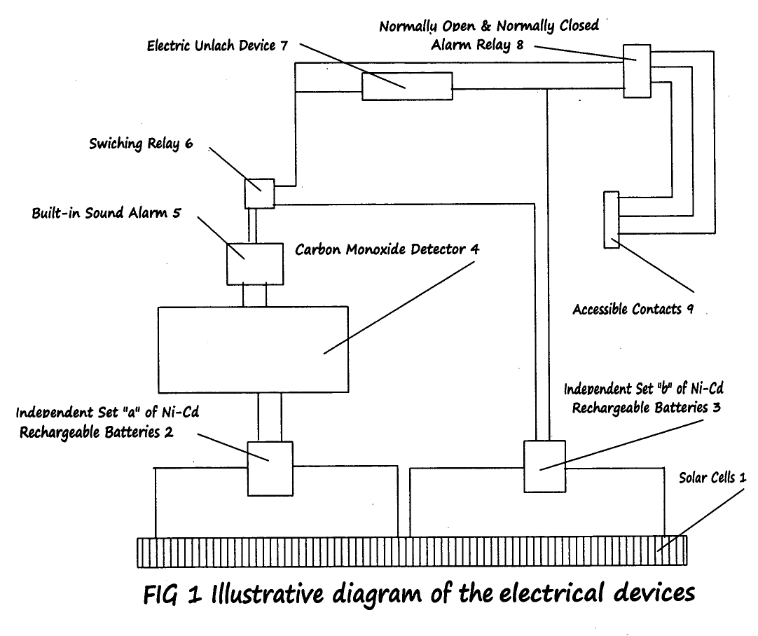

Referring to the drawing in FIG. 1 it discloses an illustrative diagram of the electrical devices, self contained and self powered, built-in in the jamb of this novel window, the Solar cells 1, exposed to the outside environment uninterruptedly, are connected to the Independent Set “a” of Ni—Cd Rechargeable Batteries 2, and to the independent set “b” of Ni—Cd rechargeable batteries 3, to maintain in full charge, both sets of Ni—Cd rechargeable batteries.

The independent set “a” of Ni—Cd rechargeable batteries 2 supplies the electrical power to the carbon monoxide detector 4, the Built-in sound Alarm 5 and the Switching Relay 6.

When the carbon monoxide detector 4 senses the predetermined level of carbon monoxide, it will trigger the Built-in sound Alarm 5, powering as well, the solenoid of the Switching Relay 6, which will switch on the Electric Unlatch device 7 and the Normally Open & Normally Closed Alarm Relay 8, powered by the independent set “b” of Ni—Cd rechargeable batteries 3.

As a result, the Electric Unlatch device 7 will unlatch the lock handle mounted in the window sash of sub-claim 8, therefore the set of heavy-duty steel springs mounted between the window jam and the window sash will push the window sash open to allow the concentrated carbon monoxide inside the room to escape; as well letting the outside clean air to enter the room to reduce the concentration of carbon monoxide inside the bedroom, to save the occupant's lives.

In addition, as the Normally Open & Normally Open Alarm Relay 8, is activated by the Switching Relay 6, powered by the independent set “b” of Ni—Cd rechargeable batteries 3, it will connect the Accessible Contacts 9, described in the sub-claim 3, and will trigger the alarm of the private central station alarm company to alert the Fire & Police Department to provide immediate assistance to humans and/or animals and to protect the opened affected structure of the residence if, at the time of the occurrence the residence is unoccupied.

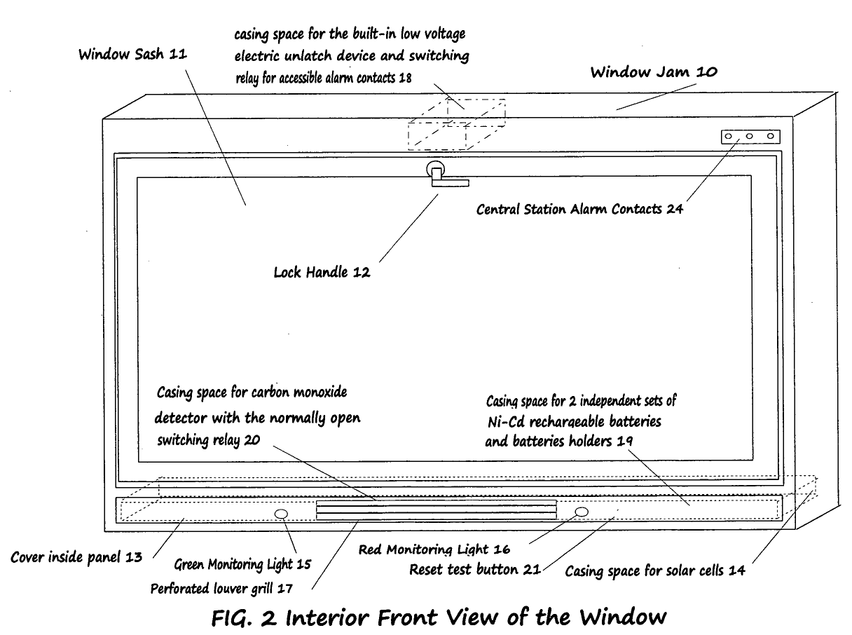

Referring to the drawing in FIG. 2, it discloses the interior front view of the new window and the location of the devices of claim 1, wherein it shows the window jam 10, with a casing space for the built-in low voltage electric unlatch device and the switching relay for accessible alarm contacts 18 described in sub-claim 3, the Central Station Alarm Contacts 24, the window sash 11, of sub-claim 10, with the lock handle 12, mounted in the window sash to manually open and close the window described in sub-claim 8.

The Cover inside panel 13, with a Perforated louver grill 17 to expose the carbon monoxide sensor of sub-claim 2 and the Green monitoring light 15, the Red monitoring light 16 and the test button 21, is mounted in the bottom inside part of the window jam 10 to cover the Casing space for carbon monoxide detector with the normally open switching relay 20, the Casing space for 2 independent sets of Ni—Cd rechargeable batteries and batteries holders 19 and the Casing space for solar cells 14, as well as to access all the electrical devices to be serviced.

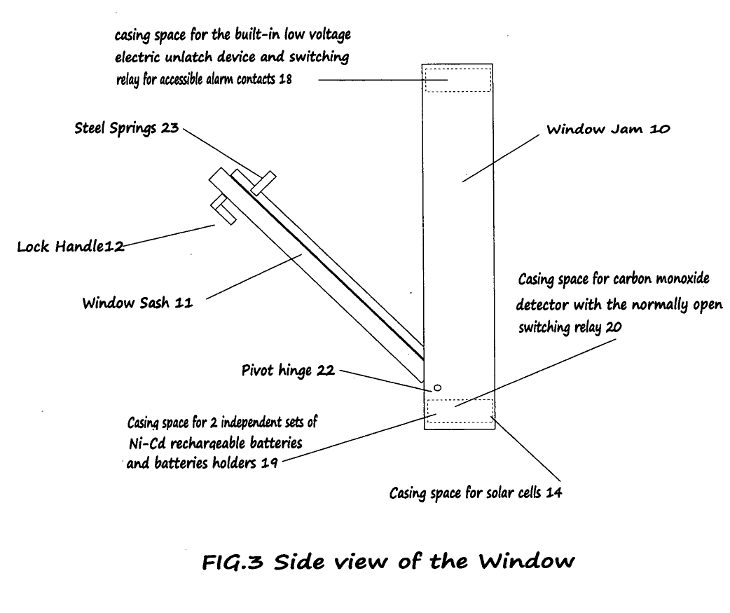

The drawing of FIG. 3 shows the side view of the window with the Window sash 11, half way open, as an illustration.

The Window Jam 10, shows the Casing space for the built-in low voltage electric unlatch device an switching relay for accessible contacts 18, the Casing space for carbon monoxide detector with the normally open switching relay 20; the Casing space for 2 independent sets of Ni—Cd rechargeable batteries and batteries holders 19; and the Casing space for solar cells 14, as well the location of the Pivot hinges 22.

The Window sash 11, show the Lock Handle 12, and the built-in Steel Springs 23, that push the window sash open after the built-in electric low voltage unlatch device of sub-claim 3, release the lock handle in sub-claim 8, mounted in the window sash triggered by the attached relay of the carbon monoxide detector device of sub-claim 2.

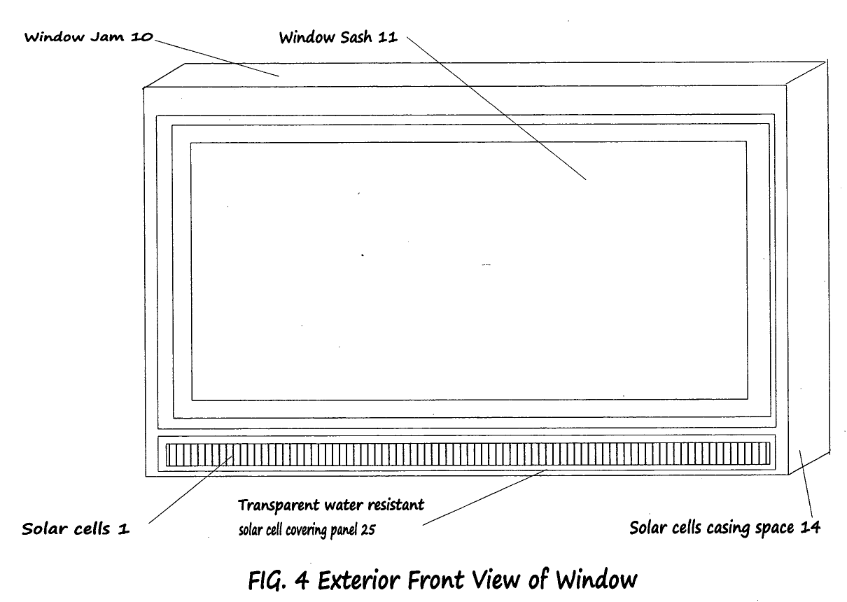

The drawing in FIG. 4, discloses the exterior front view of the new window, wherein it shows the Window Jam 10, the Window sash 11, the Solar cells 1 enclosed in the exterior side of the window seal that is part of the Window Jam 10 and the Casing space for solar cells 14, including the Transparent water resistant solar cell covering panel 25, to cover the Casing space for solar cells 14 as described in sub-claim 4.

The above detailed description of the drawings was based specifically in a “Hopper Window”, only to describe the function of this new invention and as set forth above are intended to be illustrative only, as described in sub-claim 13, this new “Bedroom window that opens it self to prevent carbon monoxide poisoning without external electrical supply”, can be manufactured in different jam designs and be able to accommodate the self-contained and preassembled devices of claim 1 and corresponding sashes, to be used in different windows beside a Hopper window; as a Casement window, Owing window, Double Hang window, Gliding window, as well custom made elliptical, circle top, oval, arch, transoms and triangular windows.

While one embodiment has been described, the hoper window, numerous variations and modifications will occur to those skilled in the art, the invention is not limited to the embodiment disclosed and its scope is defined by the way of the flowing claims.

I claim:

1. A self-contained lifesaver bedroom window that can detect carbon monoxide within a room, with a new built-in carbon monoxide detector, that when it senses the predetermined level of carbon monoxide, it activates a relay connected to the terminals of the carbon monoxide built-in sound alarm that power the electric unlatch device mounted in the window jamb, releasing the lock handle mounted in the window sash, allowing the window sash with pivoted hinges, to pop open pushed by a set of built-in springs to allow the concentrated carbon monoxide inside the room to escape; as well letting the outside clean air to enter the room to reduce the concentration of carbon monoxide inside the bedroom saving the occupants' lives, without the need of any external electrical supply, replaceable alkaline batteries or any human action; the electrical devices in this self-contained novel window are powered by two independent set of Ni—Cd rechargeable batteries, charged by a built-in solar cells located in the exterior side of the window seal, protected by a transparent water resistant solar cell covering panel; all the devices are self-contained, in a built-in casing space in the window jamb, a louvered panel in the interior side of the window expose the sensor of the carbon monoxide detector to the inside environment of the room, as well the monitoring lights and the reset button, this panel is accessible and removable to service the built-in devices, also this window include a normally open & normally close relay with accessible contacts to be connected to a private central station alarm company, which in turn, would alert the Fire & Police Department to provide immediate assistance to humans and/or animals as well as to protect the opened affected residence or building, if at the time of the occurrence the residence or building is unoccupied; additionally, the handle mounted in the sash, can manually open and close the window for normal use, as a regular window, without triggering the carbon monoxide alarm, therefore the private alarm connected to the Fire & Police Department or interfering with the functions and protection of this new lifesaver bedroom window; this new window can be installed in new construction homes and buildings, as well as a replacement window for existing homes and buildings, and can be manufactured in different sizes and styles like: hopers, owning, casement, double hangs, gliding, including custom transoms, to accommodate any architectural designs for residential homes, as well for, hotels, dormers, hospitals, commercial institutions, assisting living facilities, and any other place or facility where human or animals live in or sleep; another advantage is that the installation of this new window requires the same skills needed to install a regular window, no electrical work or electrical power supply is needed, as well as any other specialized trade mechanics; and as with a regular window, any private alarm company can install burglary alarm contacts without interfering with the described functions and protection of this new window.

2. A self-contained lifesaver bedroom window that can detect carbon monoxide within a room of claim 1 wherein the built-in carbon monoxide detector that comprises a normally open switching relay, connected to the terminals of the carbon monoxide detector's sound alarm device; this switching relay will activate the low voltage electric unlatch device when the carbon monoxide detector senses the predetermined level of carbon monoxide; as well the solenoid of a low voltage normally open or normally close switching relay, to be connected to a private central station alarm company, the carbon monoxide, the sound alarm and the switching relay devices are powered by an independent set of Ni—Cd rechargeable batteries, charged by a solar cells device built-in in the exterior side of the window seal.

3. A self-contained lifesaver bedroom window that can detect carbon monoxide within a room of claim 1, wherein the built-in low voltage electric unlatch device connected by the switching relay of the carbon monoxide detector, described in the sub-claim 2, to unlatch the spring loaded window sash, when the above carbon monoxide detector senses the predetermined level of carbon monoxide, to pop the window open; this low voltage electric unlatch device and a low voltage normally open or normally close switching relay (to be connected to a private central station alarm company), are powered by an independent set of Ni—Cd rechargeable batteries, charged by a solar cell device.

4. A self-contained lifesaver bedroom window that can detect carbon monoxide within a room of claim 1, wherein the solar cells device that keep the two independent sets of Ni—Cd rechargeable batteries fully charged to supply electrical power to the described devices in claim 1, sub-claim 2 and sub-claim 3; this solar cell device is enclosed in the exterior seal of the window and protected by a transparent water resistant solar cell covering panel, part of the window jamb and the casing space for the built-in devices, wherein exposing the solar cell to the exterior natural light as well protecting the solar cells from the exterior environment.

5. A self-contained lifesaver bedroom window that can detect carbon monoxide within a room of claim 1, wherein it has the two independent sets of Ni—Cd rechargeable batteries, batteries holders and related connections; the set “a” to supply electrical power to the carbon monoxide detector, the carbon monoxide detector's sound alarm device, and the switching relay's solenoid, described in sub-claim 2 and the set “b” to supply electrical power to the unlatch device described in sub-claim 3 and the normally open or normally dose switching relay, (to be connected to a private central station alarm company), described in sub-claim 3 and sub-claim 7.

6. A self-contained lifesaver bedroom window that can detect carbon monoxide within a room of claim 1, wherein it has the window jam with a built-in casing space on the upper part of the jam to contain the low voltage electric unlatch device described in sub-claim 3, and the low voltage normally open or normally close switching relay for the accessible alarm contacts (to be connected to a private central station alarm company) described in the sub-claim 7, a built-in casing space on the lower part of the jam to contain the carbon monoxide detector, the carbon monoxide detector's sound alarm device, the normally open switching relay described in sub-claim 2, the two independent sets of Ni—Cd rechargeable batteries and batteries holders described in sub-claim 5, the solar cell device to maintain charged the two independent sets of Ni—Cd rechargeable batteries, protected by the transparent water resistant solar cell covering panel as described in sub-claim 4 and a inside removable cover panel with a perforated louver grill and perforations to expose the carbon monoxide sensor to the environment of the room, the green & red monitoring lights and the reset/test button of the new carbon monoxide detector described in the claim 1 and in the sub-claim 2.

7. A self-contained lifesaver bedroom window that can detect carbon monoxide within a room of claim 1, wherein it has the accessible contacts connected to a built-in low voltage normally open or normally dose switching relay, controlled by the low voltage unlatch device described in sub-claim 3, to be connected to a private central station alarm company to alert the Fire & Police Department when the built-in carbon monoxide detector of sub-claim 2 sense the predetermined level of carbon monoxide.

8. A self-contained lifesaver bedroom window that can detect carbon monoxide within a room of claim 1, wherein it has the lock handle mounted in the window sash to manually open and dose the window without triggering the carbon monoxide alarm, or the private alarm connected the Fire & Police Department or interfering with the functions and protection of this new lifesaver bedroom window.

9. A self-contained lifesaver bedroom window that can detect carbon monoxide within a room of claim 1, wherein it has a set of heavy-duty steel springs built-in in the window sash; to push the window sash open after the built-in low voltage electric unlatch device of sub-claim 3 releases the lock handle in sub-claim 8, mounted in the window sash, when triggered by the switching relay of the carbon monoxide detector device of sub-claim 2.

10. A self-contained lifesaver bedroom window that can detect carbon monoxide within a room of claim 1, wherein the window sash with a built-in set of heavy-duty steel springs allows the window sash to pop the window sash open after the built-in electric low voltage unlatch device of sub-claim 3, release the lock handle in sub-claim 8, triggered by the switching relay of the carbon monoxide detector device of sub-claim 2.

11. A self-contained lifesaver bedroom window that can detect carbon monoxide within a room of claim 1, wherein the built-in pivoted hinges let the window sash pop fully open, to accomplish the maximum air circulation in & out of the bedroom, pushed by the set of heavy duty steel springs of sub-claim 9.

12. A self-contained lifesaver bedroom window that can detect carbon monoxide within a room of claim 1, wherein the structure of a self contained, pre-assembled window can be installed in new construction; as well as a replacement window, without the need of removing the existing window jam, as well the existing exterior, and interior window trim, making simple to install this novel bedroom window in place of an existing window, without any damage to the existing walls of the house.

13. A self-contained lifesaver bedroom window that can detect carbon monoxide within a room of claim 1, wherein it allows different jam designs to be used to accommodate the self-contained and preassembled devices of claim 1, and corresponding sashes to be used in different windows as: Hopper window, Casement window, Owing window, Double Hang window, Gliding window, as well custom made elliptical, circle top, oval, arch, transoms and triangular windows.

14. A self-contained lifesaver bedroom window that can detect carbon monoxide within a room of claim 1, wherein it has the ability to operate by itself using only the energy of the exterior light to power all electrical devices without the need and dependency of unreliable house utility power, and or replaceable alkaline batteries.

15. A self-contained lifesaver bedroom window that can detect carbon monoxide within a room of claim 1, wherein it has the feature of being a self-contained window with pre-assembled electrical and mechanical devices, that can be installed as a regular window by a carpenter eliminating the need of other professional trades or any electric wiring through the walls.
